(19) United States
(12) Patent Application Publication
(10) Pub. No.: US 2004/0008511 A1
(43) Pub. Date: Jan. 15, 2004

(54) Auto-engaging structure of a bulb assembly

(76) Inventor: Sen-Hung Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/190,676

(22) Filed: Jul. 9, 2002

(51) Int. Cl. H01R 33/00

(52) U.S. Cl. 362/226; 362/806; 362/396

(57) ABSTRACT

The present invention relates to an auto-engaging structure of a bulb assembly, which includes a holder connecting with a bulb and then received in a shell. The characteristic is that the holder is provided with an elastic hook and the shell is provided with a connector with an inner channel. When the holder is inserted into the shell, the elastic hook can be passed through the channel of the connector to provide the holder automatically engaged with the shell firmly.

### BACKGROUND OF THE INVENTION

A conventional bulb assembly includes a holder to connect with a bulb and a shell. The holder with the bulb is received in the shell. This connection between the holder and the shell is not tight. The holder with the bulb is often loose relating to the shell that causes bad conductive connection of electric contact. There are some improvements but still out of work.

The primary object of the invention is to provide an auto-engaging structure of a bulb assembly, which includes a holder having an elastic hook and a shell having a connector with an inner channel that provides a better engagement for the holder and the shell. Now the features and advantages of the present invention will be described in detail with reference to the accompanying drawings.

### BRIEF DESCRIPTION OF ACCOMPANYING DRAWINGS

FIG. 1 is an exploded perspective view showing an auto-engaging structure of a bulb assembly according to the present invention.

FIG. 2 is an assembled perspective view of FIG. 1.

FIGS. 3-5 are plan views showing the connecting procedures between the holder and the shell.

FIGS. 6-8 are top plan views of FIGS. 3-5.

### DETAILED DESCRIPTION OF PREFERRED EMBODIMENTS

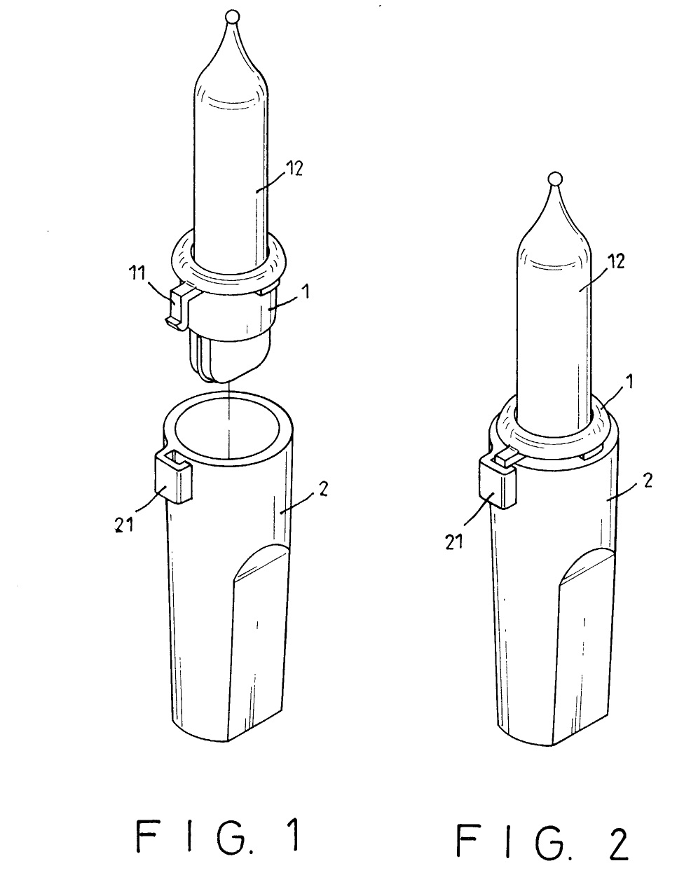

Please refer to FIGS. 1 and 2, the present invention includes a holder (1) with a bulb (12) and a shell (2). The characteristic is that the holder (1) is provided with an elastic hook (11) and the shell (2) is provided with a connector (21). When the holder (1) is inserted into the shell (2), the elastic hook (11) can pass through the inner channel of the connector (21) that makes the holder (1) connect with the shell (2) firmly.

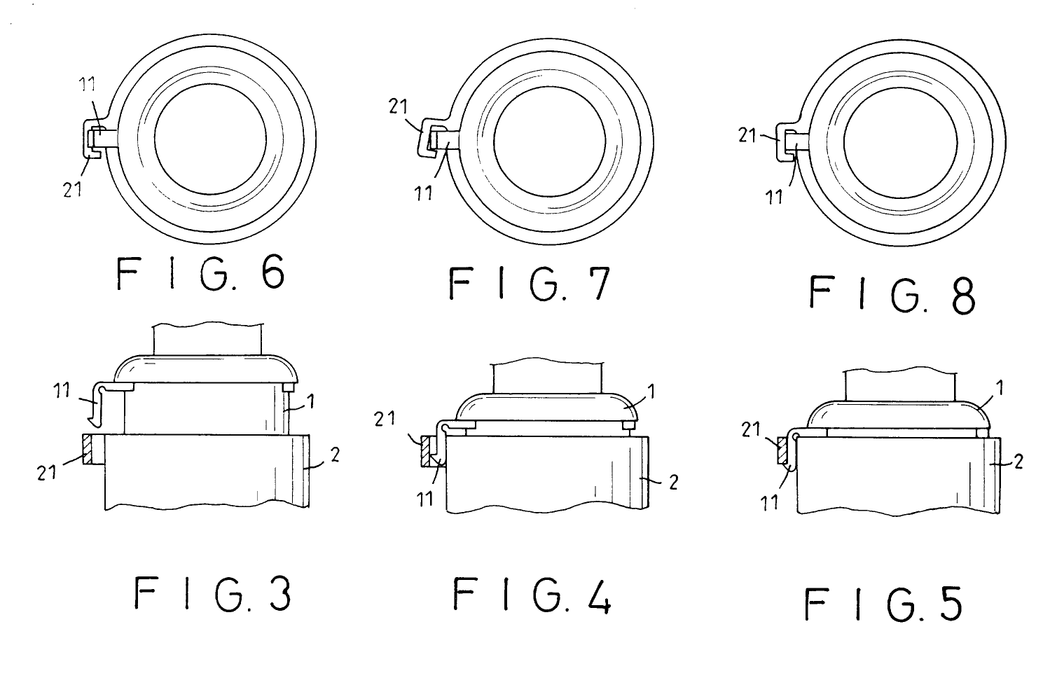

Referring to FIGS. 3 to 8, since the elastic hook ( 11) and the connector (21) are made of elastic material, the connector (21) will be pushed outward (FIGS. 4, 7) during the hook (11) inserts into the channel. After the engagement is completed, the connector (21) is recovery while the tip end of the elastic hook (11) is engaged thereunder, as shown in FIGS. 5, 8. A secure connection is then obtained automatically.

What is claimed is:

1. An auto-engaging structure of a bulb assembly including a holder connecting with a bulb and then received in a shell, and the characteristic is the holder being provided with an elastic hook and the shell being provided with a connector with an inner channel; the holder being inserted into the shell, and the elastic hook being engaged with the connector to provide the holder being automatically engaged with the shell firmly.
